(19) United States
(12) Patent Application Publication
(10) Pub. No.: US 2024/0276532 A1
(43) Pub. Date: Aug. 15, 2024

(54) SYSTEMS, METHODS, AND DEVICES FOR RATE ADAPTATION FOR DATA THROUGHPUT ENHANCEMENT IN WIRELESS DEVICES

(71) Applicant: Cypress Semiconductor Corporation, San Jose, CA (US)

(72) Inventors: Vikram Kumar Ramanna, San Jose, CA (US); Kiran ULN, Pleasanton, CA (US); Ashutosh Pandey, Irvine, CA (US); Rakesh Taori, McKinney, TX (US)

(73) Assignee: Cypress Semiconductor Corporation, San Jose, CA (US)

(21) Appl. No.: 18/107,888

(22) Filed: Feb. 9, 2023

(51) Int. Cl. H04W 72/541; G06N 3/08; H04B 17/345; H04W 72/12

(52) U.S. Cl. CPC H04W 72/541; G06N 3/08; H04B 17/345; H04W 72/12

(57) ABSTRACT

Systems, methods, and devices enhance data throughput in wireless devices. Methods may include determining, using a processing device comprising processing elements, a plurality of wireless parameters representing wireless data features on a wireless communications channel, and determining, using the processing device, a plurality of interference parameters based, at least in part, on the plurality of wireless parameters, the plurality of interference parameters identifying interference events on the wireless communications channel. The methods may also include generating one or more data transmission pattern modifications based, at least in part, on the plurality of interference parameters.

### TECHNICAL FIELD

This disclosure generally relates to wireless devices, and more specifically, to enhancement of data throughput of transceivers in such wireless devices.

### BACKGROUND

Wireless devices may communicate with each other via one or more wireless modalities, such as a Wi-Fi connection or a Bluetooth connection. Accordingly, such wireless communication may be implemented in a manner compliant with a wireless protocol. Moreover, such wireless devices may include various hardware components to facilitate such communication. For example, wireless devices may include transmission media that may include one or more transceivers and antennas. In a wireless environment, multiple wireless devices may be present, and may communicate with common devices over common wireless media. Conventional techniques for managing activity of such wireless devices in a wireless environment remain limited because they are not able to efficiently account for interference that may occur between devices in such a wireless environment.

### BRIEF DESCRIPTION OF THE DRAWINGS

FIG. 1 illustrates an example of a system for data throughput enhancement, configured in accordance with some embodiments.

FIG. 2 illustrates an example of a device for data throughput enhancement, configured in accordance with some embodiments.

FIG. 3 illustrates an example of a method for data throughput enhancement, performed in accordance with some embodiments.

FIG. 4 illustrates another example of a method for data throughput enhancement, performed in accordance with some embodiments.)

FIG. 5 illustrates an example of a method for data throughput, performed in accordance with some embodiments.

FIG. 6 illustrates an example of a method for data throughput, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may communicate with each other via one or more wireless modalities, such as a Wi-Fi connection or a Bluetooth connection. Such wireless devices may be configured as access points (APs) and stations. Moreover, in a wireless environment, there may be multiple APs and stations. More specifically, a single station may be in communication with two or more APs. As will be discussed in greater detail below, such APs might not be in communication with each other, and accordingly, transmissions between the APs might conflict with each other resulting in collisions, also referred to herein as interference events. Conventional techniques for addressing such collisions remain limited because they may require reduction in data rates, as may occur in response to data traffic collisions, or blocking unnecessarily long sections of available bandwidth. Such techniques result in lower data throughput, and higher overall power consumption due to increase times associated with device usage.

Various embodiments disclosed herein provide the ability to dynamically determine and implement data transmission adaptation operations to identify and compensate for interferences between APs. As will be discussed in greater detail below, various information may be retrieved that describes devices and activity on a wireless network connection. Moreover, existing data traffic may also be retrieved, and such information may be used to identify interference events as well as patterns of interference. Accordingly, as will be discussed din greater detail below, the retrieved information may be used to train a machine learning model, and the machine learning model may be used to predict an anticipated pattern of interference. The predicted pattern of interference events may be used to schedule network traffic as well as configure components of the wireless communications channel. For example, a data rate may remain unchanged, but power save operations may be scheduled at anticipated busy times corresponding to interference events. In this way, predicted interference patterns may be used to adaptively configure use of the transmission medium without sacrificing a data transmission rate.

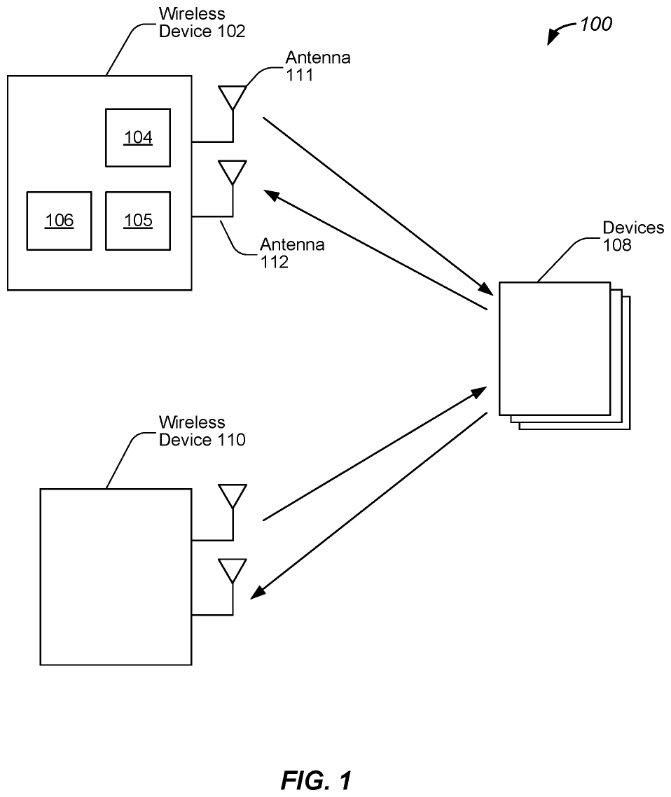

FIG. 1 illustrates an example of a system for data throughput enhancement, configured in accordance with some embodiments. Accordingly, a system, such as system 100, may include wireless devices that are used for wireless communications, and are also configured to be able to perform data transmission adaptation operations as disclosed herein. As will be discussed in greater detail below, wireless devices included in system 100 may be configured to dynamically determine and implement data transmission adaptation operations to anticipate and compensate for interference between access points.

In various embodiments, system 100 may include wireless device 102 which may be a wireless communications device. As discussed above, such wireless devices may be compatible with one or more wireless transmission protocols, such as a Wi-Fi protocol, a Bluetooth protocol, a near field communications (NFC) protocol, a Zigbee protocol, or an ultra-wideband (UWB) protocol. Accordingly, while examples disclosed herein are described with reference to Wi-Fi and Bluetooth protocols, any suitable wireless transmission protocols may be used. In some embodiments, wireless device 102 includes collocated radios. For example, wireless device 102 may include a Wi-Fi radio and a Bluetooth radio that share access to a communications medium. For example, wireless device 102 may include a first transceiver, such as transceiver 104, and a second transceiver, such as transceiver 105. Transceiver 104 may be compatible with a Wi-Fi specification and protocol, and transceiver 105 may be compatible with a Bluetooth specification and protocol. For example, the Bluetooth protocol may be a Bluetooth Low Energy (BLE) protocol, also referred to as Bluetooth Smart. In some embodiments, wireless device 102 may be a smart device, such as those found in wearable devices, or may be a monitoring device, such as those found in smart buildings, environmental monitoring, and energy management. It will be appreciated that such wireless devices may be any suitable device, such as those found in cars, other vehicles, and even medical implants.

As shown in FIG. 1, various wireless communications devices may be in communication with each other via one or more wireless communications mediums. More specifically, wireless device 102 may include one or more antennas, such as antenna 111 and antenna 112, and may also include processing device 106. As discussed above, wireless device 102 may also include collocated transceivers, such as transceiver 104 and transceiver 105. As disclosed herein a transceiver as well as its associated transmit and receive chains and processing logic may be referred to as a radio. As will be discussed in greater detail below, such processing devices, transceivers, and radios may be configured to establish communications connections with other devices, and transmit data in the form of data packets via such communications connections. Accordingly, wireless devices, such as wireless device 102, are configured to dynamically determine and implement data transmission adaptation operations to anticipate and compensate for interference between access points, or other entities. In various embodiments, wireless device 102 may be configured as either an access point or a station.

In some embodiments, system 100 may further include devices 108 which may also be wireless devices. As similarly discussed above, devices 108 may be compatible with one or more wireless transmission protocols, such as a Wi-Fi protocol or a Bluetooth protocol. In some embodiments, devices 108 may be configured as stations in communication with wireless device 102. For example, devices 108 may be smart devices or other devices, such as those found in gaming systems, cars, other vehicles, and medical implants. In some embodiments, devices 108 may be access points, or software enabled access points (SoftAP). In various embodiments, devices 108 may be different types of devices than wireless device 102. As discussed above, each of devices 108 may include one or more antennas, as well as processing devices and transceivers, which may also be configured to establish communications connections with other devices, and transmit data in the form of data packets via such communications connections. As discussed above, devices 108 may also be configured to dynamically determine and implement data transmission adaptation operations to anticipate and compensate for interference patterns.

As shown in FIG. 1, system 100 may also include wireless device 110 which may be another wireless device in communication with devices 108. In one example, both wireless device 102 and wireless device 110 may be configured as access points (APs), and may be in communication with devices 108. Accordingly, in this example, wireless device 102 and wireless device 110 might not be aware of each other, but may both be communicating with devices 108. Accordingly, transmissions from each of wireless device 102 and wireless device 110 may interfere with each other respectively when trying to communicated with devices 108. As will be discussed in greater detail below, devices disclosed herein are configured to dynamically determine and implement data transmission adaptation operations to anticipate and compensate for interference between access points.

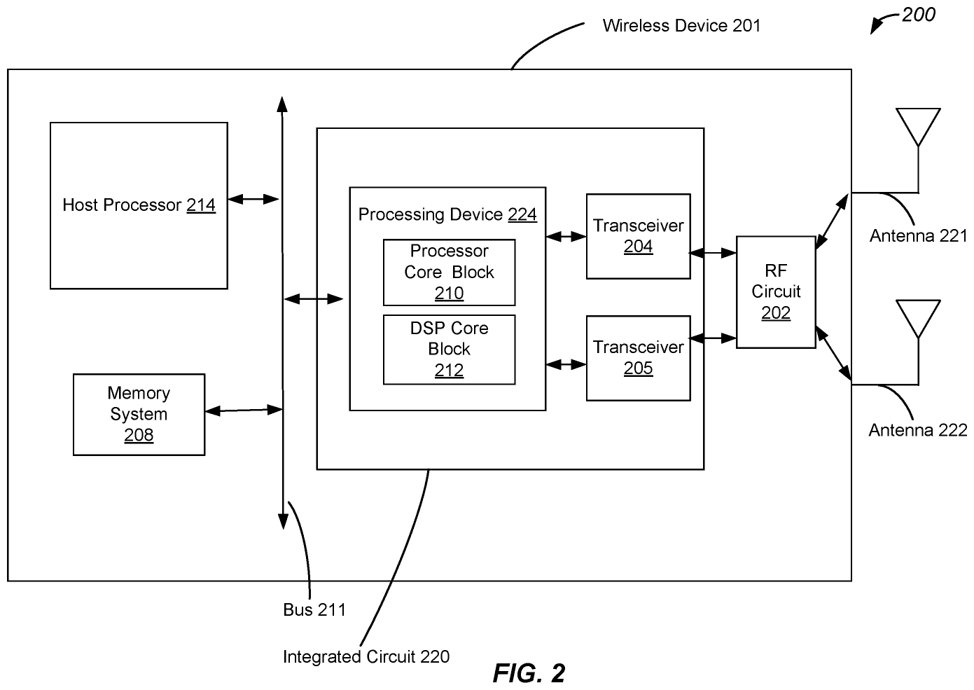

FIG. 2 illustrates an example of a device for data throughput enhancement, configured in accordance with some embodiments. More specifically, FIG. 2 illustrates an example of a system, such as system 200, that includes wireless device 201. It will be appreciated that wireless device 201 may be one of any of the wireless devices discussed above with reference to FIG. 1, such as wireless device 102, devices 108, and/or wireless device 110.

In various embodiments, wireless device 201 includes one or more transceivers, such as transceiver 204 and transceiver 205. In one example, system 200 includes transceiver 204 which is configured to transmit and receive signals using a communications medium that may include antenna 221 or antenna 222. As noted above, transceiver 204 may be a Wi-Fi transceiver. Accordingly, transceiver 204 may be compatible with a Wi-Fi communications protocol, such as an 802.11ax protocol. It will be appreciated that while the 802.11ax protocol is provided as an example, any suitable wireless transmission protocol may be used. Accordingly, transceiver 204 may be compatible with various other Wi-Fi protocols, or any other suitable wireless transmission protocol capable of implementing the techniques disclosed herein. In various embodiments, transceiver 204 includes a modulator and demodulator as well as one or more buffers and filters, that are configured to generate and receive signals via antenna 221 and/or antenna 222.

System 200 additionally includes transceiver 205 which may be collocated with transceiver 204 in wireless device 201. In various embodiments, transceiver 205 is also configured to transmit and receive signals using a communications medium that may include antenna 221 or antenna 222. Accordingly, transceiver 205 may be a Bluetooth transceiver compatible with a Bluetooth communications protocol. In one example, the Bluetooth protocol may be a Bluetooth Low Energy (BLE) protocol. Moreover, transceiver 205 includes a modulator and demodulator as well as one or more buffers and filters, that are configured to generate and receive signals via antenna 221 and/or antenna 222. While various embodiments are described with reference to Bluetooth and Wi-Fi communications protocols, it will be appreciated that any suitable protocol may be used.

In various embodiments, system 200 further includes processing device 224 which may include logic implemented using processing elements and/or one or more processor cores. Accordingly, processing device 224 is configured to perform data transmission adaptation operations, as will be discussed in greater detail below. More specifically, processing elements included in processing device 224 may be configured to perform data transmission adaptation operations as disclosed herein. In some embodiments, the processing elements may be implemented in firmware included in processing device 224.

Moreover, processing device 224 includes one or more components configured to implement a medium access control (MAC) layer that is configured to control hardware associated with a wireless transmission medium, such as that associated with a Wi-Fi transmission medium. In one example, processing device 224 may include processor core block 210 that may be configured to implement a driver, such as a Bluetooth and/or Wi-Fi driver. Processing device 224 may further include digital signal processor (DSP) core block 212 which may be configured to include microcode.

In various embodiments, processor core block 210 comprises multiple processor cores which are each configured to implement specific portions of a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. In various embodiments, a host stack may include layers for a Bluetooth network encapsulation protocol, radio frequency communication, service discovery protocol, as well as various other high-level data layers. Moreover, a controller stack may include a link management protocol, a host controller interface, a link layer which may be a low energy link layer, as well as various other timing critical layers.

System 200 further includes radio frequency (RF) circuit 202 which is coupled to antenna 221 and antenna 222. In various embodiments, RF circuit 202 may include various components such as an RF switch, a diplexer, and a filter. While FIG. 2 illustrates system 200 as having two antennas, it will be appreciated that system 200 may have a single antenna, or any suitable number of antennas, which may number more than two. Accordingly, RF circuit 202 may be configured to select an antenna for transmission/reception, and may be configured to provide coupling between the selected antenna, such as antenna 221, and other components of system 200 via a bus, such as bus 211. While one RF circuit is shown, it will be appreciated that wireless device 201 may include multiple RF circuits. Accordingly, each of multiple antennas may have its own RF circuit. Moreover, each one may be associated with a particular wireless communications protocol, such as a first antenna and RF circuit for Wi-Fi and a second antenna and RF circuit for Bluetooth.

System 200 includes memory system 208 which is configured to store one or more data values associated with data transmission adaptation operations discussed above and in greater detail below. Accordingly, memory system 208 includes storage device, which may be a non-volatile random access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204, transceiver 205, and processing device 224 may be implemented on the same integrated circuit chip, such as integrated circuit chip 220. In another example, transceiver 204, transceiver 205, and processing device 224 may each be implemented on their own chip, and thus may be disposed separately as a multi-chip module or on a common substrate such as a printed circuit board (PCB) or a multi-die chip implemented in the same package. It will also be appreciated that components of system 200 may be implemented in the context of a low energy device, a smart device, or a vehicle such as an automobile. Accordingly, some components, such as integrated chip 220, may be implemented in a first location, while other components, such as antenna 221, may be implemented in second location, and coupling between the two may be implemented via a coupler such as RF circuit 202.

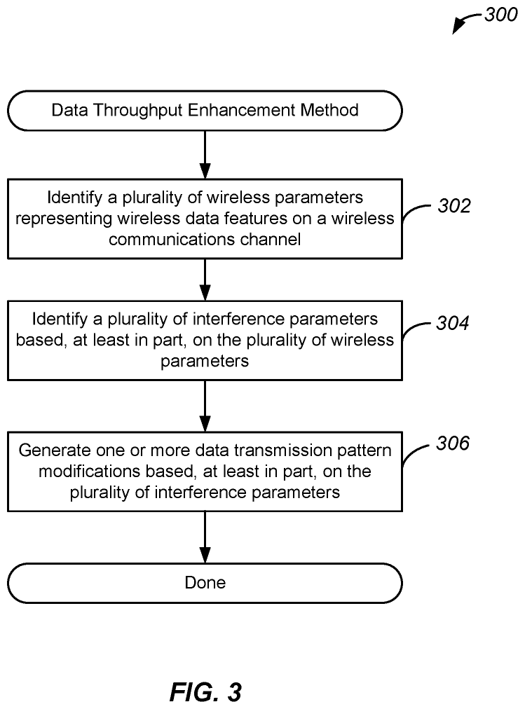

FIG. 3 illustrates an example of a method for data throughput enhancement, performed in accordance with some embodiments. Accordingly, a method, such as method 300, may be performed to dynamically implement data transmission adaptation operations as disclosed herein. As will be discussed in greater detail below, performing such data transmission adaptation operations may enable the anticipation of and compensation for interference between transmission of different access points received by a station.

Method 300 performs operation 302 during which a plurality of wireless parameters may be identified. In various embodiments, the wireless parameters may represent wireless data features on a wireless communications channel. For example, the wireless parameters may include various available network information such as existing wireless devices using the wireless communications channel. The wireless parameters may also include other channel information such as an amount of noise determined by a noise metric, as well as an amount of data being sent over the wireless communications channel. The wireless parameters may also include other metrics, such as signal strength or quality metrics or a modulation coding scheme (MCS) index. Accordingly, during operation 302, the appropriate information underlying the wireless parameters may be identified and retrieved by a wireless device.

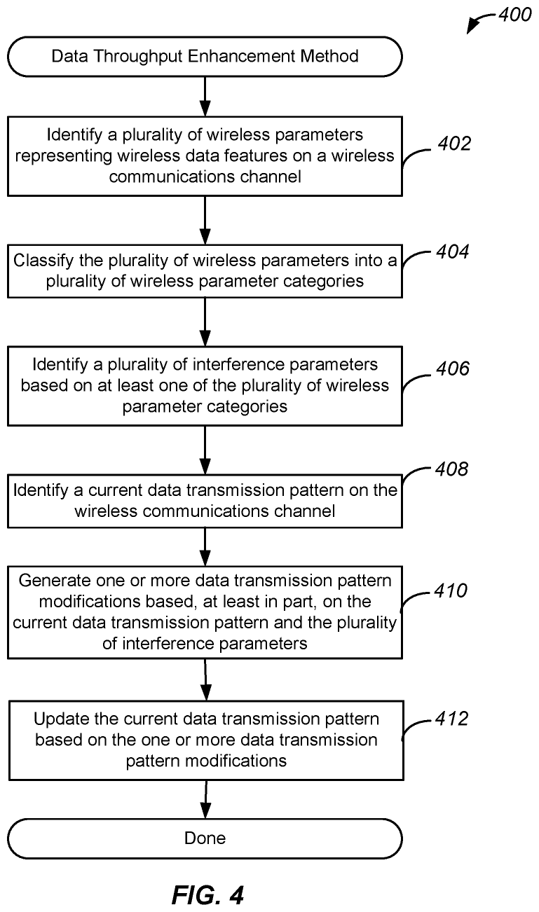

Method 300 performs operation 304 during which a plurality of interference parameters may be identified based, at least in part, on the plurality of wireless parameters. In various embodiments, the interference parameters may be used to classify features and attributes of the wireless parameters to identify interference events as well as patterns of interference. Additional details regarding how such interference parameters are determined are discussed in greater detail below with reference to FIGS. 4-6.

Method 300 performs operation 306 during which one or more data transmission pattern modifications may be generated based, at least in part, on the plurality of interference parameters. Accordingly, one or more data transmission pattern modifications may be generated and implemented to compensate for identified interferences. In one example, a data rate may be changed. In another example, the data rate is not changed, but instead an anticipated medium busy pattern is generated, and used to schedule traffic to avoid collisions with identified interference events. In this way, the data transmission pattern may be dynamically modified to avoid interference and collisions while avoiding a reduction in data rate.

FIG. 4 illustrates another example of a method for data throughput enhancement, performed in accordance with some embodiments. Accordingly, a method, such as method 400, may be performed to dynamically implement data transmission adaptation operations as disclosed herein. As will be discussed in greater detail below, one or more machine learning techniques may be implemented to generate estimates of interference activity, and use such estimates to modify a transmission pattern to avoid such interference activity. In this way, network traffic collisions may be reduced, and data rate decreases may also be reduced.

Method 400 performs operation 402 during which a plurality of wireless parameters may be identified. As discussed above, the wireless parameters may represent wireless data features on a wireless communications channel. For example, the wireless parameters may include various available network information such as existing wireless devices using the wireless communications channel. The wireless parameters may also include other channel information such as an amount of noise determined by a noise metric, as well as an amount of data being sent over the wireless communications channel. The wireless parameters may also include other metrics, such as signal strength or quality metrics or a modulation coding scheme (MCS) index.

Accordingly, during operation 402, the appropriate information underlying the wireless parameters may be identified and retrieved by a wireless device which may be an access point, or may be a station. In one example, the plurality of wireless parameters is identified and retrieved by an access point in communication with multiple stations. Accordingly, the access point may perform one or more polling operations or queries if needed to obtain the wireless parameters.

Method 400 performs operation 404 during which the plurality of wireless parameters may be classified into a plurality of wireless parameter categories. As will be discussed in greater detail below, one or more machine learning techniques may be used to classify identified features of activity on a wireless connection into different categories, and thus categories particular wireless activity as interreference. Accordingly, machine learning models may be configured to distinguish interference activity from other network activity, and further configured to generate estimations of predicted patterns of interfering activity. For example, a machine learning model may be a machine learning classifier that classifies identified features of a wireless channel, as given by the wireless parameters, into one of thermal noise or interference. The machine learning model may also classify the identified features as OBSS, microwave interference, Bluetooth activity, ultrawideband communication (UWB), nearfield communication (NFC), cellular activity, as well as radar activity.

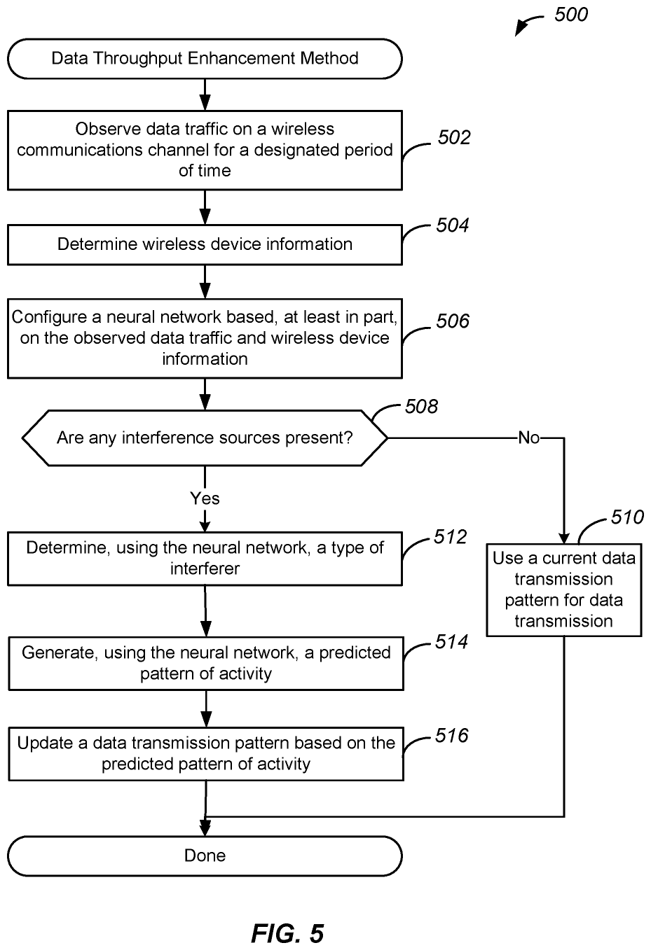

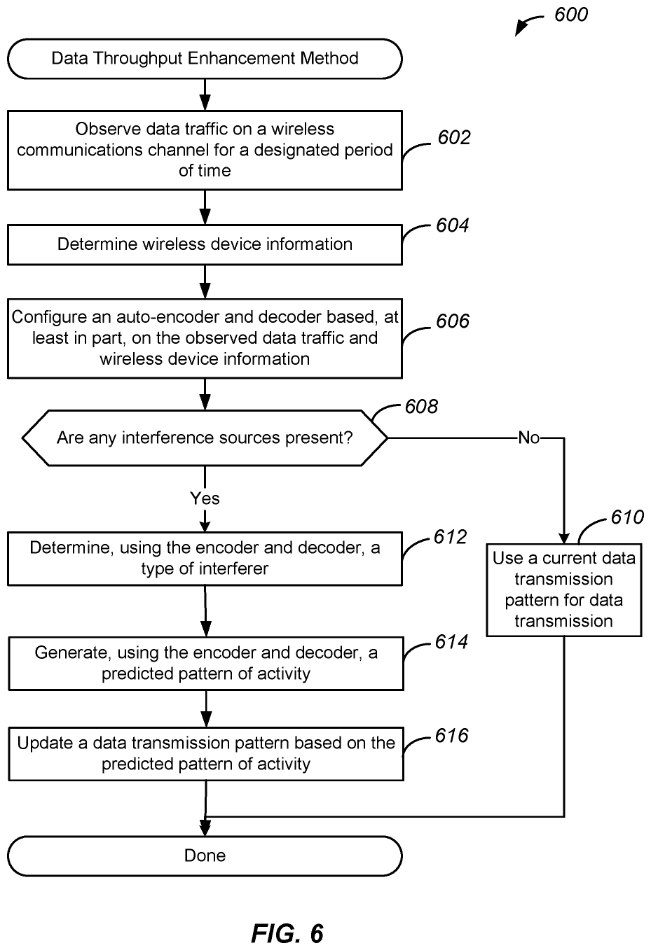

In some embodiments, the machine learning techniques may include the generation and application of a neural network. Accordingly, as will be discussed in greater detail below, a neural network may be trained based on training data obtained during a learning phase. The neural network may be configured to receive inputs identifying one or more wireless parameters, and to generate an output identifying categories for the wireless parameters, as well as predicted patterns of activity. In one example, the machine learning technique may be an autoencoder neural network. Accordingly, the machine learning technique may be a neural network that is configured to learn a representation of interference patterns by training the neural network to ignore non-interference events and activity. Additional details regarding the generation and application of machine learning models are discussed in greater detail below with reference to FIGS. 5 and 6.

Method 400 performs operation 406 during which a plurality of interference parameters may be identified based on at least one of the plurality of wireless parameter categories. As discussed above, an output of the machine learning model may identify interference events as well as an estimated pattern of activity for such interference events. In some embodiments, various features of the interference events may be identified and stored as interference parameters. For example, a type of interferer may be identified based on one or more designated identifiers as well as an estimated period and estimated duration or duty of the interference.

Method 400 performs operation 408 during which a current data transmission pattern may be identified for the wireless communications channel. Accordingly, an expected data transmission pattern for an upcoming data transmission period may be retrieved. Such information may be determined based on a previously negotiated network traffic schedule or other signal, such as an RF active signal.

Method 400 performs operation 410 during which one or more data transmission pattern modifications may be generated based, at least in part, on the current data transmission pattern and the plurality of interference parameters. Accordingly, one or more data transmission pattern modifications may be generated and implemented to compensate for identified interferences. In one example, the previously determined interference pattern represented by the interference parameters is used as an anticipated medium busy pattern, and also used to re-schedule traffic to avoid collisions with identified interference events.

In another example, the transmitter may adjust a transmission pattern to delay transmission until a predicted termination of the identified interferences. Moreover, after the delay, the transmitter may check to see if the interference is gone by listening to the channel for a designated period of time, and may transmit once the interference is confirmed to have terminated. If the interference continues after the delay period, the transmitter may wait for an additional delay period, and may store the results as modifications. Accordingly, adjustments and modifications may be made based on observed data that is used to refine the accuracy of predicted patterns of interference.

Method 400 performs operation 412 during which the current data transmission pattern may be updated based on the one or more data transmission pattern modifications. Accordingly, the current data transmission pattern may be modified based on the plurality of interference parameters such that the updated data transmission pattern is used for the upcoming data transmission period.

FIG. 5 illustrates an example of a method for data throughput, performed in accordance with some embodiments. Accordingly, a method, such as method 500, may be performed to dynamically implement data transmission adaptation operations as disclosed herein. As will be discussed in greater detail below, one or more machine learning models may be trained and configured to generate estimates of interference activity, and use such estimates to modify a transmission pattern to avoid such interference activity. In this way, a method, such as method 500, may be performed to configure a neural network, and implement the neural network for data transmission adaptation operations.

Method 500 performs operation 502 during which data traffic may be observed on a wireless communications channel for a designated period of time. Accordingly, a learning or training period may be observed in which wireless traffic is observed on a wireless communications channel. Accordingly, during the training period, data transmission/reception events may be observed, and data representing such events may be stored. For example, transmission/reception events may have corresponding timestamps, durations, as well as one or more other metrics, such as a signal strength or power level. All such data may be stored as training data.

Method 500 performs operation 504 during which additional wireless information may be determined. Accordingly, one or more identifiers configured to identify wireless devices associated with the previously described events may also be stored. For example, such identifiers may be device identifiers for one or more stations and access points using the wireless communications channel, and such identifiers may be obtained from data packets sent on the wireless communications channel. Moreover, additional data may be received from other devices via the wireless communications channel. The additional data may include messages providing reports of one or more interference events during the designated period of time. For example, a station may report how many packet errors it experienced as well as additional data associated with such packet errors, such as timestamps.

Method 500 performs operation 506 during which a neural network may be configured based, at least in part, on the observed data traffic and wireless device information. Accordingly, the training data may be used to configure a neural network to generate a classier configured to classify transmission/reception events, and identify interference events. As similarly discussed above, the interference events may be classified into different categories such as noise, aperiodic interferer, and periodic interferer. Moreover, the neural network may also be configured to predict a pattern of activity for the one or more types of interference events.

In some embodiments, the training data may be generated based on one or both of real-life observations captured in an operational environment of a wireless device as well as observed data captured in a test environment. Accordingly, a learning phase or learning period may be implemented to capture such data, and the data may be used as training data. In one example, such training data may be generated by an entity, such as a manufacturer, using test conditions to simulate specific types of interference. For example, in a test environment, interference from other devices, such as cellular phones and other access points associated with common household smart devices, may be modeled and profiled in the test environment, and may be stored as part of the training data. In this way, the training data used to train the neural network may include one or more of previously generated training data and real-time observed data.

In various embodiments, additional learning phases may be implemented to periodically update the neural network. In one example, the previously generated training data may be deployed to all stations in communication with an access point, and each station may implement its own additional learning phase to further train the neural network of each station for that specific station's activity and circumstance. In this way, training data may be adapted to each deployed wireless device.

Method 500 performs operation 508 during which it may be determined if any interferences are present. Accordingly, once the neural network model has been constructed, network traffic may continue to be observed, and observed data may be provided to the neural network model. In various embodiments, the neural network model may then classify transmission/reception events, and determine if any interference events are present based on the results of the classification. If it is determined that no interferences are present, method 500 may proceed to operation 510 during which a current data transmission pattern may be used for data transmission.

If it is determined that interferences are present, method 500 may proceed to operation 512 during which a type of interferer may be determined. As discussed above, the neural network model may classify events into one or more categories. Accordingly, during operation 512, an output of the neural network model may identify which types of interferers are present. As previously discussed, the training data may be fed into the neural network model as time series data that represents aspects of interference such as length, periodicity, and frequency along with a type of interference detected, as may be represented by a unique identifier, during a training period. The neural network may then classify features of the observed data into interferences such as OBSS, microwave interference, Bluetooth activity, UWB, NFC, cellular activity, as well as radar activity.

Method 500 performs operation 514 during which a predicted pattern of activity may be generated. Accordingly, a predicted pattern of interference activity may be generated based on the observed activity and identified types of interferers. Accordingly, as discussed above, the neural network may be configured to classify what may be considered encoded parameters of an interferer based on observed data. More specifically, an observed pattern of interference may be decoded to identify and classify interferers. Conversely, if a type of interferer is identified, the neural network may be configured to generate an estimated pattern of activity based on the reverse. More specifically, the configuration of the neural network may enable the regeneration of a pattern of activity based on a given type of interferer. In this way, the neural network may be configured to convert the identified types of interferers into a predicted pattern of interference.

Method 500 performs operation 516 during which a data transmission pattern may be updated based on the predicted pattern of activity. More specifically, the data transmission pattern may be updated to avoid scheduling of data transmissions during the predicted interference activity. As similarly discussed above, the transmitter may adjust a transmission pattern to delay transmission until a predicted termination of the identified interferences. Moreover, after the delay, the transmitter may check to see if the interference is gone by listening to the channel for a designated period of time, and may transmit once the interference is confirmed to have terminated. If the interference continues after the delay period, the transmitter may wait for an additional delay period, and may store the results as modifications. Accordingly, adjustments and modifications may be made based on observed data that is used to refine the accuracy of predicted patterns of interference.

FIG. 6 illustrates an example of a method for data throughput, performed in accordance with some embodiments. Accordingly, a method, such as method 600, may be performed to dynamically implement data transmission adaptation operations as disclosed herein. As will be discussed in greater detail below, one or more machine learning models may be trained and configured to generate estimates of interference activity, and use such estimates to modify a transmission pattern to avoid such interference activity. In this way, a method, such as method 600, may be performed to configure an autoencoder model, and implement the autoencoder model for data transmission adaptation operations.

Method 600 performs operation 602 during which data traffic may be observed on a wireless communications channel for a designated period of time. Accordingly, wireless traffic may be observed on a wireless communications channel, and data representing various data transmission/reception events, as well as other events, may be observed, and data representing such events may be stored.

Method 600 performs operation 604 during which wireless information may be determined. Accordingly, one or more identifiers configured to identify wireless devices associated with network traffic may also be stored. For example, such identifiers may be device identifiers for one or more stations and access points using the wireless communications channel, and such identifiers may be obtained from data packets sent on the wireless communications channel. Moreover, additional data may be received from other devices via the wireless communications channel.

Method 600 performs operation 606 during which an autoencoder may be configured based, at least in part, on observed data traffic and wireless device information. Accordingly, the stored data may be used to configure the autoencoder to classify transmission/reception events, and identify interference events. In some embodiments, the autoencoder model may be configured to identify outliers as interference events. Moreover, the interference events may be classified into different categories such as noise, aperiodic interferer, and periodic interferer. Moreover, the neural network may also be used to predict a pattern of activity for the one or more types of interference events.

In various embodiments, the autoencoder may be configured to include an encoder, a bottleneck, and a decoder. The encoder may be configured to compress a train-validate-test data set into an encoded representation. The input data may include time series data, such as time series data of energy levels, data rates, as well as other observable features on a communications channel. The bottleneck may be configured to contain the compressed representations of a reduced set of features. For example, the bottleneck may contain nodes that represent a type of interference as well as one or more parameters, such as periodicity, of the types of interference. The decoder may be configured to decompress and reconstruct data. In this example, the decoder may be configured to reconstruct observation data. In some embodiments, the decoder is configured to re-create observed features and generate blocks or patterns of predicted interference.

Method 600 performs operation 608 during which it may be determined if any interferences are present. Accordingly, once the autoencoder model has been configured, network traffic may be observed, and observed data may be provided to the autoencoder model. In various embodiments, the autoencoder model may then classify transmission/reception events, and determine if any interference events are present based on the results of the classification. If it is determined that no interferences are present, method 600 may proceed to operation 610 during which a current data transmission pattern may be used for data transmission.

If it is determined that interferences are present, method 600 may proceed to operation 612 during which a type of interferer may be determined. As discussed above, the autoencoder model may classify events into one or more categories. For example, time series data that represents aspects of interference such as length, periodicity, and frequency, may be fed into the autoencoder model which may then classify features of the observed data into interferences such as OBSS, microwave interference, Bluetooth activity, UWB, NFC, cellular activity, as well as radar activity. Accordingly, during operation 612, an output of the autoencoder model may identify which types of interferers are present.

Method 600 performs operation 614 during which a predicted pattern of activity may be generated. Accordingly, a predicted pattern of interference activity may be generated based on the observed activity and identified types of interferers. As previously discussed, the autoencoder model may classify features of the observed data into interferences such as OBSS, microwave interference, Bluetooth activity, UWB, NFC, cellular activity, as well as radar activity. Moreover, the configuration of the autoencoder model may enable the regeneration of a pattern of activity based on a given type of interferer. In this way, the autoencoder model may be configured to convert the identified types of interferers into a predicted pattern of interference

Method 600 performs operation 616 during which a data transmission pattern may be updated based on the predicted pattern of activity. More specifically, the data transmission pattern may be updated to avoid scheduling of data transmissions during the predicted interference activity. As similarly discussed above, a transmitter may adjust a transmission pattern to delay transmission until a termination of the identified interferences, and delay periods may be stored as modifications. Accordingly, adjustments and modifications may be made based on observed data that is used to refine the accuracy of predicted patterns of interference.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
determining, using a processing device comprising processing elements, a plurality of wireless parameters representing wireless data features on a wireless communications channel;
determining, using the processing device, a plurality of interference parameters based, at least in part, on the plurality of wireless parameters, the plurality of interference parameters identifying interference events on the wireless communications channel; and
generating one or more data transmission pattern modifications based, at least in part, on the plurality of interference parameters.

2. The method of claim 1, wherein the plurality of wireless parameters comprises data values identifying a plurality of wireless devices, and further identifying activity on the wireless communications channel.

3. The method of claim 2, wherein the plurality of interference parameters is determined using a neural network.

4. The method of claim 3, wherein the neural network is configured based, at least in part, on data received from the plurality of wireless devices.

5. The method of claim 4, wherein the neural network is configured to classify the plurality of interference parameters to identify the interference events, and is further configured to generate a predicted pattern of interference events.

6. The method of claim 2, wherein the plurality of interference parameters is determined using an autoencoder.

7. The method of claim 6, wherein the autoencoder is configured based, at least in part, on observed activity on the wireless communications channel.

8. The method of claim 7, wherein the autoencoder is configured to classify the plurality of interference parameters to identify the interference events, and is further configured to generate a predicted pattern of interference events.

9. The method of claim 1, wherein the generating of the one or more data transmission pattern modifications further comprises:
generate a predicted pattern of interference events based, at least in part, on the plurality of interference parameters; and
generating a medium busy pattern based on the predicted pattern of interference events.

10. A system comprising:
a transceiver configured to be compatible with a wireless communications protocol; and
processing elements coupled to the transceiver, the processing elements being configured to:
determine a plurality of wireless parameters representing wireless data features on a wireless communications channel;
determine a plurality of interference parameters based, at least in part, on the plurality of wireless parameters, the plurality of interference parameters identifying interference events on the wireless communications channel; and
generate one or more data transmission pattern modifications based, at least in part, on the plurality of interference parameters.

11. The system of claim 10, wherein the plurality of wireless parameters comprises data values identifying a plurality of wireless devices, and further identifying activity on the wireless communications channel.

12. The system of claim 11, wherein the plurality of interference parameters is determined using a neural network, and wherein the neural network is configured based, at least in part, on data received from the plurality of wireless devices.

13. The system of claim 12, wherein the neural network is configured to classify the plurality of interference parameters to identify the interference events, and is further configured to generate a predicted pattern of interference events.

14. The system of claim 11, wherein the plurality of interference parameters is determined using an autoencoder, and wherein the autoencoder is configured based, at least in part, on observed activity on the wireless communications channel.

15. The system of claim 14, wherein the autoencoder is configured to classify the plurality of interference parameters to identify the interference events, and is further configured to generate a predicted pattern of interference events.

16. A device comprising:
processing elements configured to:
determine a plurality of wireless parameters representing wireless data features on a wireless communications channel;
determine a plurality of interference parameters based, at least in part, on the plurality of wireless parameters, the plurality of interference parameters identifying interference events on the wireless communications channel; and
generate one or more data transmission pattern modifications based, at least in part, on the plurality of interference parameters.

17. The device of claim 16, wherein the plurality of interference parameters is determined using a neural network, and wherein the neural network is configured based, at least in part, on data received from a plurality of wireless devices associated with the wireless communications channel.

18. The device of claim 17, wherein the neural network is configured to classify the plurality of interference parameters to identify the interference events, and is further configured to generate a predicted pattern of interference events.

19. The device of claim 16, wherein the plurality of interference parameters is determined using an autoencoder, and wherein the autoencoder is configured based, at least in part, on observed activity on the wireless communications channel.

20. The device of claim 19, wherein the autoencoder is configured to classify the plurality of interference parameters to identify the interference events, and is further configured to generate a predicted pattern of interference events.
